(19) United States
(12) Patent Application Publication
(10) Pub. No.: US 2005/0002529 A1
(43) Pub. Date: Jan. 6, 2005

(54) Extended walsh code space for forward packet data channel in IS-2000 system

(76) Inventor: Rath Vannithamby, San Diego, CA (US)

Correspondence Address: COATS & BENNETT, PLLC, P O BOX 5, RALEIGH, NC, 27602, US

(21) Appl. No.: 10/869,259

(22) Filed: Jun. 16, 2004

Related U.S. Application Data
(60) Provisional application No. 60/478,980, filed on Jun. 17, 2003.

(51) Int. Cl. H04K 1/00

(52) U.S. Cl. 380/255

(57) ABSTRACT

The present invention provides a signaling method to indicate the Walsh code set allocated to a forward packet data channel shared by a plurality of mobile stations. The radio base stations broadcasts a Walsh space bitmap to the mobile stations over a forward control channel to indicate a set of available Walsh codes used by the forward packet data channel. Additionally, the radio base stations transmits a control message indicating the mobile station scheduled to receive the forward packet data channel, wherein the control message includes a Walsh code space expander that identifies an unused Walsh code that is not included in the set of available Walsh codes identified by the Walsh space bitmap.

### RELATED APPLICATIONS

This application claims priority under 35 U.S.C. § 119(e) from the following provisional application: Application Ser. No. 60/478,980 filed on Jun. 17, 2003. That application is incorporated in its entirety by reference herein.

### BACKGROUND OF THE INVENTION

Revision C of the IS-2000 Standard introduced a forward packet data channel to satisfy the demand for high speed packet data services, such as web browsing, email, and streaming services. Earlier versions of the IS-2000 standard supported both voice and data users with dedicated traffic channels. Voice traffic is transported at rates of up to 14.4 kilobits per second over the fundamental channel (FCH). Packet data at rates up to 307.2 kilobits per second is transmitted over the supplemental channel (SCH) in both the forward and reverse directions. Dedicated traffic channels are well suited for real time traffic, such as voice. Most data applications, however, differ from voice in two significant respects. Most packet data is bursty in nature and is tolerant of delays. The F-PDCH takes advantage of these characteristics of packet data to improve throughput and more efficiently use the radio resources.

The F-PDCH is a shared channel. The basic idea underlying the F-PDCH is to use all available forward link resources, such as Walsh codes and power, to transmit data to one user at a time. Throughput is maximized if all the available resources are used to transmit data to the mobile station with the best channel conditions and, hence, the highest supportable data rate. In actual practice, a fairness criterion may be used to ensure that users subject to poor channel conditions are not ignored for lengthy periods of time. The end result is that packet data transmissions to mobile stations are time multiplexed on the F-PDCH and transmitted at full power, but with data rates and slot lengths that vary according to channel conditions. By taking advantage of multi-user diversity and preferentially scheduling users with good channel conditions, significant increases in capacity can be realized.

The increase in capacity realized by implementing the F-PDCH for high speed packet data comes at the cost of greater signaling overhead. The mobile stations need to feed back channel quality information (CQI) to the base station, which is used by the base station to schedule downlink transmissions to the mobile stations on the F-PDCH. Further, the mobile stations need to be informed about the resources allocated to the F-PDCH. It is desirable to use all available Walsh codes not allocated to the forward dedicated channels for the forward packet data channel in order to maximize throughput. Some of the Walsh codes, however, are reserved for overhead channels and some may be allocated to forward dedicated channels, such as the FCH and SCH. Thus, the number of Walsh codes allocated to forward dedicated channels will vary over time. The radio base station must have some way of informing the mobile stations what Walsh codes are allocated to the F-PDCH. The radio base station must also indicate the target mobile station for packet data transmissions on the F-PDCH.

In Revision C of the IS-2000 Standard, a forward overhead channel known as the forward packet data control channel (F-PDCCH) is used to transmit information from the radio base station to the mobile stations needed to decode data transmissions on the F-PDCH. Overhead messages on the F-PDCCH are transmitted concurrently with packet data transmissions on the F-PDCH. The packet data control message identifies the mobile station to receive the concurrent packet data transmission on the F-PDCH. The packet data control message is also used to send a Walsh space bitmap. The Walsh space bitmap indicates to the mobile stations the Walsh code set available to the F-PDCH. Each bit in the Walsh space bitmap corresponds to two Walsh codes. The radio base station sets each bit in the Walsh space bitmap to indicate whether the corresponding Walsh codes are available for use by the F-PDCH. A bit value of “1” in the Walsh space bitmap indicates to the mobile station that the corresponding Walsh codes are not used by the F-PDCH.

Because each bit position in the Walsh code bit map corresponds to two length-32 Walsh codes, there will be times when one of the length-32 Walsh codes marked as unavailable will, in fact, be unused. Additional increases in system capacity could be realized if Walsh code channels indicated as unavailable by the Walsh code bit map but not actually in use by a forward dedicated channel could be allocated to the F-PDCH.

### SUMMARY OF THE INVENTION

The present invention provides a method of indicating the Walsh code set allocated to a forward packet data channel shared by a plurality of mobile stations. The radio base station broadcasts a Walsh space bitmap to the mobile stations over a forward control channel to indicate a set of available Walsh codes used by the forward packet data channel. The Walsh space bitmap comprises a plurality of bits with each bit of the Walsh space bitmap designating two or more Walsh codes. The value of bits comprising the Walsh space bitmap indicate the availability of the corresponding Walsh codes for use by the forward packet data channel. Additionally, the radio base station transmits a control message indicating the mobile station scheduled to receive the forward packet data channel. The control message includes a Walsh code space expander that identifies an unused Walsh code that is not included in the set of available Walsh codes identified by the Walsh space bitmap. The mobile stations include in the Walsh code set for the forward packet data channel, the Walsh codes indicated as available by the Walsh space bitmap and the unused Walsh code identified in the Walsh code space expander. The Walsh code space expander provides a 4 to 50% increase in the Walsh code space for the forward packet data channel depending on channel usage.

### BRIEF DESCRIPTION OF THE DRAWINGS

FIG. 1 is a diagram of an exemplary wireless communication network according to one or more embodiments of the present invention.

FIG. 2 is a diagram of exemplary functional details for a radio base station according to the present invention.

FIG. 3 is a functional block diagram of an exemplary mobile station according to the present invention.

FIG. 4 illustrates the message format for overhead messages transmitted over the F-PDCCH.

FIGS. 5-9 illustrate the use of a Walsh space bitmap and Walsh code space expander according to the present invention to indicate the Walsh code set for the F-PDCH.

### DETAILED DESCRIPTION OF THE INVENTION

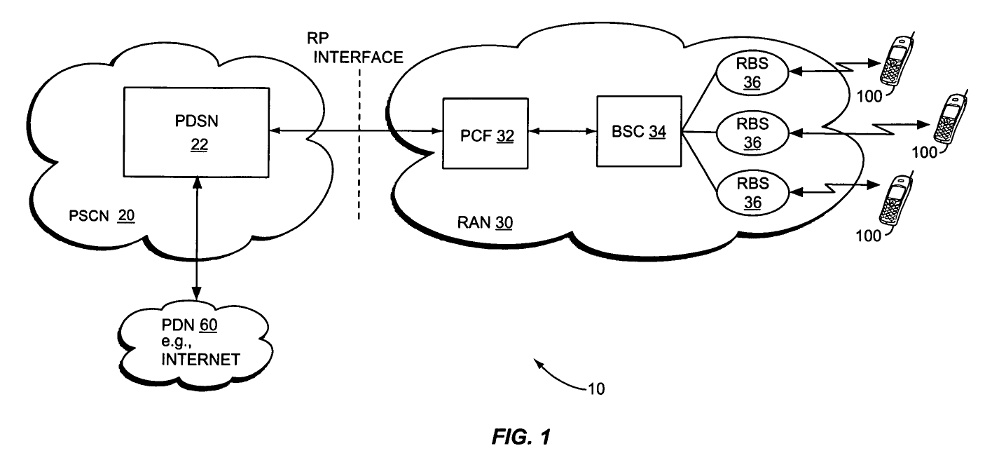

Turning to the drawings, FIG. 1 illustrates an exemplary wireless communication network 10 in which the present invention may be implemented. Network 10 in the disclosed embodiment is Code Division Multiple Access (CDMA) network operating according to Rev C of the IS-2000 standard. However, those skilled in the art will appreciate that the present invention is not limited to use in IS-2000 networks, but may be employed in CDMA networks operating according to other standards, such as the Wideband CDMA (WCDMA) standard and UMTS standard.

Network 10 includes a Packet-Switched Core Network (PSCN) 20 and a Radio Access Network (RAN) 30. The PSCN 20 includes a packet data serving node (PDSN) 22 that provides a connection to one or more Public Data Networks (PDNs) 60, such as the Internet. The RAN 30 provides the radio interface between the mobile stations 100 and the PCSN 12. An exemplary RAN 30 comprises a Packet Control Function (PCF) 32, one or more Base Station Controllers (BSC) 34, and a plurality of Radio Base Stations (RBSs) 36 operating as specified in the IS-2000 standard. BSCs 34 connect the RBSs 36 to the PCF 32. Mobile stations 100 communicate with the RBSs 36 via the air interface.

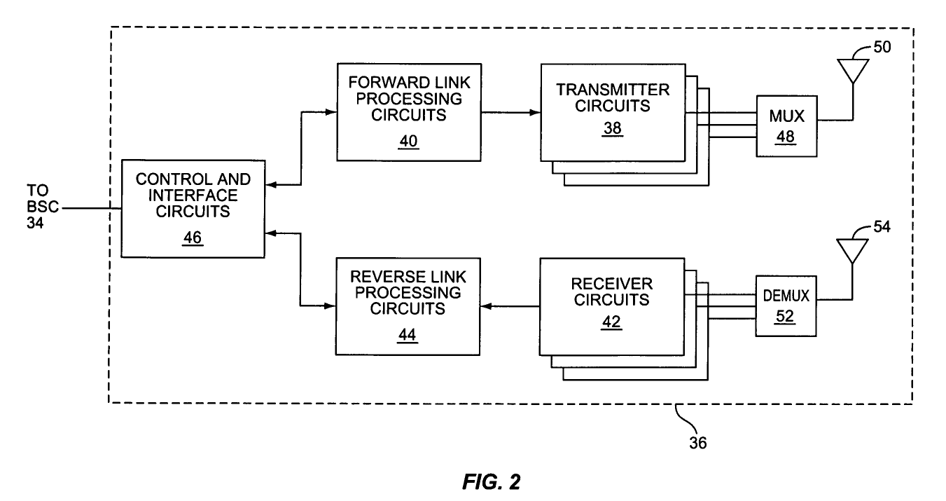

FIG. 2 illustrates a functional diagram of an exemplary RBS 36 according to one embodiment of the present invention. It will be appreciated that the present invention is not limited to the RBS architecture illustrated in FIG. 2, and that other RBS architectures are applicable to the present invention. The functional elements of FIG. 2 may be implemented in software, hardware, or some combination of both. For example, one or more of the functional elements in RBS 36 may be implemented as stored program instructions executed by one or more microprocessors or other logic circuits included in RBS 36.

As shown in FIG. 2, RBS 36 includes transmitter circuits 38, forward link signal processing circuits 40, receiver circuits 42, reverse link signal processing circuits 44, and control and interface circuits 46. The transmitter circuits 38 couple to one or more transmit antennas 50 via a multiplexer 48 and include the necessary RF circuits, such as modulators and power amplifiers, to transmit signals to mobile stations 100. The forward link signal processing circuits 40 process the signals being transmitted to the mobile stations 100. Forward link signal processing may include digital modulation, encoding, interleaving, encryption, and formatting. The receiver circuits 42 couple to one or more receive antennas 54 via a demultiplexer and comprise the RF components, such as amplifiers, filters, and downconverters and A-to-D converters, necessary to receive signals from the mobile stations 100. Reverse link processing circuits 44 process the signals received from the mobile stations 100. Reverse link processing may include, for example, digital demodulation, decoding, de-interleaving, and decryption. Control and interface circuits 46 coordinate the operation of the RBS 36 and the mobile stations 100 according to the applicable communication standards and interface the RBS 36 with the BSC 34. The forward link processing circuits 40, reverse link processing circuits 44, and control and interface circuits 46 may be integrated in a single processor, or may be implemented in multiple processors, hardware circuits, or a combination of processors and hardware circuits.

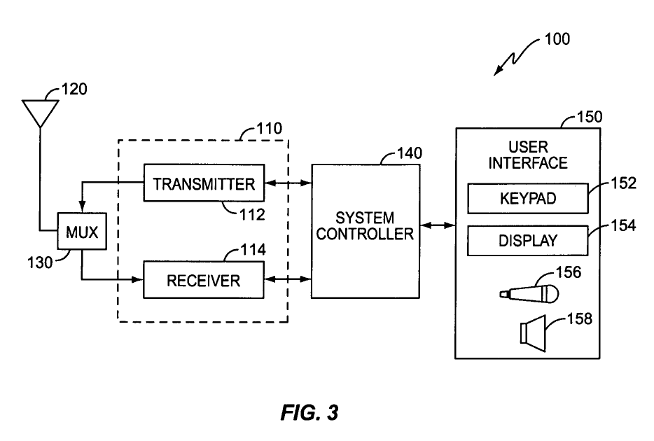

FIG. 3 is a functional block diagram of an exemplary mobile station 100 according to one embodiment of the present invention. As used herein, the term “mobile station” may include a cellular radiotelephone, a Personal Communications System (PCS) terminal that may combine a cellular radiotelephone with data processing, facsimile, and data communications capabilities; a Personal Data Assistant (PDA) that may include a pager, Web browser, radiotelephone, Internet/intranet access, organizer, calendar, and a conventional laptop and/or palmtop receiver or other appliances that include a radiotelephone transceiver.

Mobile station 100 includes a transceiver 110 connected to an antenna 120 via a multiplexer 130 as known in the art. Mobile station 100 further includes a system controller 140, and a user interface 150. Transceiver 110 includes a transmitter 112 and a receiver 114. Transceiver 110 may, for example, operate according to the IS-2000, WCDMA or UMTS standards. The present invention, however, is not limited to use with these standards and those skilled in the art will recognize the present invention may be extended or modified for other standards.

System controller 140 provides overall operational control for the mobile station 100 according to programs instructions stored in memory. System controller 140 may comprise a microprocessor or microcontroller and may be part of an application specific integrated circuit (ASIC). Memory provides storage for data, operating system programs and application programs. Memory may be integrated with the system controller 140, or may be implemented in one or more discrete memory devices.

User interface 150 allows the user to interact and control the mobile station 100. User interface 150 typically comprises a keypad 152, display 154, microphone 156 and/or speaker 158. Other input and output devices may also present. Keypad 152 allows the operator to enter commands and select menu options while display 154 allows the operator to see menu options, entered commands, and other service information. Microphone 156 converts the operator's speech into electrical audio signals and speaker 158 converts audio signals into audible signals that can be heard by the operator. It will be understood by those skilled in the art that mobile station 100 may comprise a subset of the illustrated user interface elements or mobile station 100 may comprise additional user interface elements not shown or described herein.

The RBS 36 transmits voice and packet data to the mobile stations 100 over one or more dedicated traffic channels, such as the Forward Fundamental Channel (F-FCHs) and the Forward Supplemental Channel (F-SCHs). The F-FCH is used primarily for voice communications, while the F-SCH is used primarily for real-time packet data transmissions. The RBS 36 also transmits packet data to the mobile stations 100 over a shared forward packet data channel (F-PDCH). Use of the F-PDCH for packet data transmissions is preferred for bursty, delay tolerant packet data. The RBS 36 transmits packet data to only one mobile station 100 at a time on the F-PDCH using all available power and Walsh codes. Those skilled in the art will appreciate that the F-PDCH may be divided into two or more subchannels, in which case the RBS 36 may transmit to one mobile station 100 on each subchannel. The available resources in this case are divided between the subchannels of the F-PDCH. A scheduler, which may be located at the RBS 36 or BSC 34, schedules the mobile stations 100 to receive transmissions on the F-PDCH based on channel quality information (CQI) received from the mobile stations 100 over a reverse overhead channel, such as the R-CQICH channel in IS-2000 systems. The scheduler may employ a proportionally fair scheduling algorithm or other known scheduling algorithm to determine which mobile stations 100 receive packet data transmissions. A description of other scheduling algorithms is contained U.S. patent application Ser. No. 09/972,793 filed Oct. 10, 2001 and Ser. No. 10/713,763 filed Nov. 14, 2003, which are incorporated herein by reference.

CDMA systems operating according to the IS-2000 standard use 32-ary Walsh codes for forward link transmissions. Of the 32 available Walsh codes, four are used for overhead channels, such as the Forward Pilot Channel (F-PCH). The remaining 28 channels are available for forward traffic channels, including the F-PDCH, one or more F-FCHs and one or more F-SCHs. In general, it is desirable to allocate all available Walsh codes to the F-PDCH except those in use by an overhead channel or dedicated traffic channel, e.g. F-FCH and F-SCH. The 28 Walsh codes not reserved for the overhead channels are identified by a Walsh code index (WCI), e.g. 0-27. Walsh codes are assigned from the bottom, i.e., beginning with WCI 28, when a F-FCH or F-SCH is assigned to a mobile station 100. The Walsh codes not used for dedicated traffic channels or overhead channels are used by the F-PDCH. Because the number of dedicated traffic channels in use varies over time, the number of Walsh codes available to the F-PDCH will also vary over time. In general, throughput is maximized if all available Walsh codes not used for overhead channels or dedicated traffic channels are allocated to the F-PDCH.

The F-PDCH requires a number of support channels in both the forward and reverse directions. In the reverse direction, an overhead channel is needed to transmit the CQI data to the RBS 36. In cdma200, Rev C, this channel is known as the Reverse Channel Quality Indicator Channel (R-CQICH). A Reverse Acknowledgment Channel (R-ARQ) is needed to acknowledge packets transmitted on the forward link to the mobile stations 100. In the forward direction, the Forward Packet Data Control Channel (F-PDCCH) is used to identify the mobile station 100 scheduled to receive the packet data on the F-PDCH and to transmit other parameters needed by the scheduled mobile station 100 to decode and demodulate the F-PDCH. Frames are transmitted concurrently on the F-PDCCH and F-PDCH. Frames may have a duration of 1.25 ms, 2.5 ms, or 5 ms.

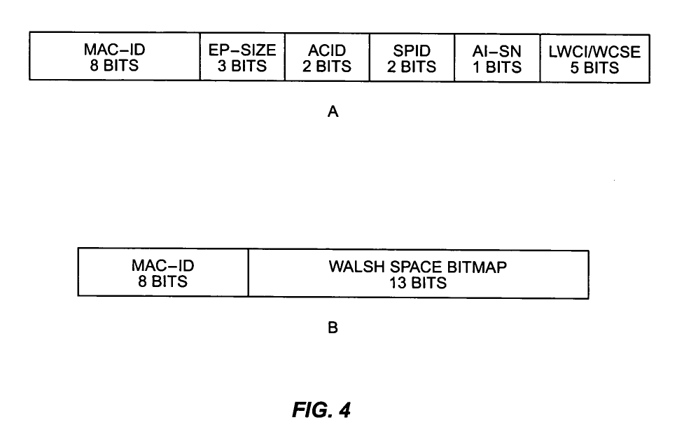

FIG. 4 shows the message format used on the F-PDCCH. The structure and content of the F-PDCCH frame in IS-2000, Rev C is well-known in the art and is described in the standards document Medium Access Control (MAC) Standard for IS-2000 Spread Spectrum Systems, Release C, 3GPP2 C. S0003-C, Ver. 1.0, May 28, 2002. The interested reader is referred to the above-noted standard for a full description of the message format for the F-PDCCH. Control messages use Format A in FIG. 4 to indicate the mobile station 100 that is scheduled to receive the F-PDCH. Control messages are typically sent each frame. Walsh code assignment messages use Format B in FIG. 4 to broadcast the Walsh code assignment for the F-PDCH. Typically, the Walsh code assignment will change at a rate much slower than the frame rate, so the Walsh code assignment message does not need to be sent every frame. The Walsh code assignment message may be sent with an average periodicity in the order of once per minute.

Except as noted below, the present invention uses the same control message format specified in the cdma200, Rev C standard. The control message (FIG. 4, Format A) includes a mobile station identifier referred to as the MAC identifier (MAC_ID). The RBS 36 sets this field to the MAC-ID of the mobile station 100 that is scheduled to receive the F-PDCH. The control message further includes a Walsh code space expander (WCSE). This information element replaces the Last Walsh Code Index (LWCI) information element in Rev C of the IS-2000 standard. In Rev C of the IS-2000 standard, the LWCI information element is used to designate a set of consecutively numbered Walsh codes used by the F-PDCH. Assuming that the Walsh code set for the F-PDCH begins with Walsh code index=0, the Walsh code set for the F-PDCH would be Walsh codes 0-LWCI in prior art systems. As explained more fully below, the present invention replaces the LWCI information element with the WCSE information element to expand the Walsh code set for the F-PDCH beyond what is possible under the current standard.

As noted above, the Walsh codes allocated to the F-PDCH may change over time. The Walsh space bitmap is sent to the mobile stations in the Walsh code assignment message (FIG. 4, Format B) on the F-PDCCH to indicate what Walsh codes are available to the F-PDCH. For the Walsh code assignment message, the MAC_ID is set to ‘00000000.’ The Walsh space bitmap comprises 13 bits that map into 26 Walsh code indices as shown in Table 1 below. Each bit in the Walsh space bitmap corresponds to two 32-length Walsh codes. A bit value of ‘1’ at a given bit position in the Walsh space bitmap indicates that the corresponding Walsh codes are unavailable for Use by the F-PDCH, because the corresponding Walsh codes have been assigned to

TABLE 1
Mapping of Walsh Space Bitmap To Walsh Code Index Values

| | Walsh Code Indexes |
|---|---|
| Bit Position | Unavailable for F-PDCH |
| 12 (MSB) | 0 and 1 |
| 11 | 2 and 3 |
| 10 | 4 and 5 |
| 9 | 6 and 7 |
| 8 | 8 and 9 |
| 7 | 10 and 11 |
| 6 | 12 and 13 |
| 5 | 14 and 15 |
| 4 | 16 and 17 |
| 3 | 18 and 19 |
| 2 | 20 and 21 |
| 1 | 22 and 23 |
| 0 (LSB) | 24 and 25 |

forward dedicated channels, such as the FCH and SCH. Due to the courseness of the Walsh space bitmap, there will be times when a Walsh code not currently in use by a forward traffic channel or overhead channel will be marked as unavailable by the Walsh space bitmap. For example, if Walsh code indices 13-25 are allocated to dedicated traffic channels, the RBS 36 will set bits 0 through 6 of the Walsh space bitmap to ‘1’ and Walsh code index 12 will be excluded from the Walsh code set for the F-PDCH, even though it is not otherwise assigned to a dedicated traffic channel or overhead channel. Throughput could be improved by assigning Walsh code index 12 to the F-PDCH, but there is no way to do so under the current standard.

According to the present invention, all Walsh codes identified as available by the Walsh space bitmap are allocated to the F-PDCH. Additionally, the WCSE information element in the packet data control message that is sent concurrently with each F-PDCH frame can be used to indicate a Walsh code that is not currently being used but is identified as unavailable by the Walsh space bitmap. If the WCSE information element points to a Walsh code marked as unavailable by the Walsh space bitmap, the mobile station 100 designated by the MAC_ID information element adds the corresponding Walsh code to the Walsh code set for the F-PDCH.

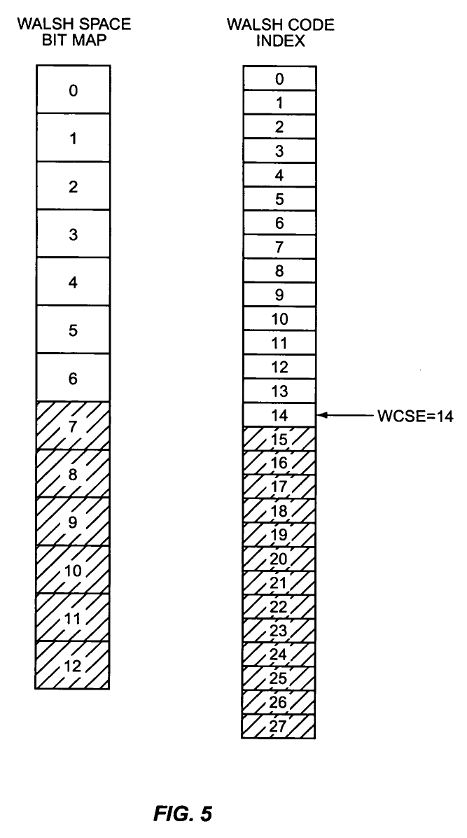

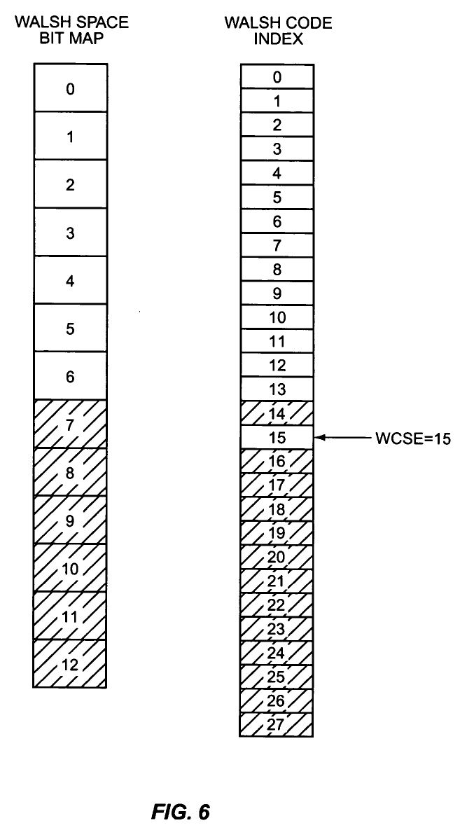

Several examples may help to illustrate the operation of the WCSE according to the present invention. In FIG. 5, bits 7-12 in the Walsh space bitmap are set to ‘1’, and the WCSE points to Walsh code index 14. According to the present invention, the mobile station 100 receiving the F-PDCH includes Walsh codes 0 through 14 in the Walsh code set for the F-PDCH. In FIG. 6, bits 7-12 in the Walsh space bitmap are set to ‘1’, and the WCSE points to Walsh code index 15. According to the present invention, the mobile station 100 receiving the F-PDCH includes Walsh codes indices 0 through 13 and 15, but not Walsh code index 14, in the Walsh code set for the F-PDCH. As these examples show, the WCSE allows one extra Walsh code to be included in the Walsh code set for the F-PDCH that would not otherwise be available in prior art systems. When the available number of Walsh codes for the F-PDCH is small, the effect of adding one more Walsh code is significant. For example, when the available number of Walsh codes identified by the Walsh space bitmap is 24, adding one more increases the Walsh space by 4%, however, when the available number of Walsh codes identified by the Walsh space bitmap is 2, adding one more will increase the Walsh space by 50%.

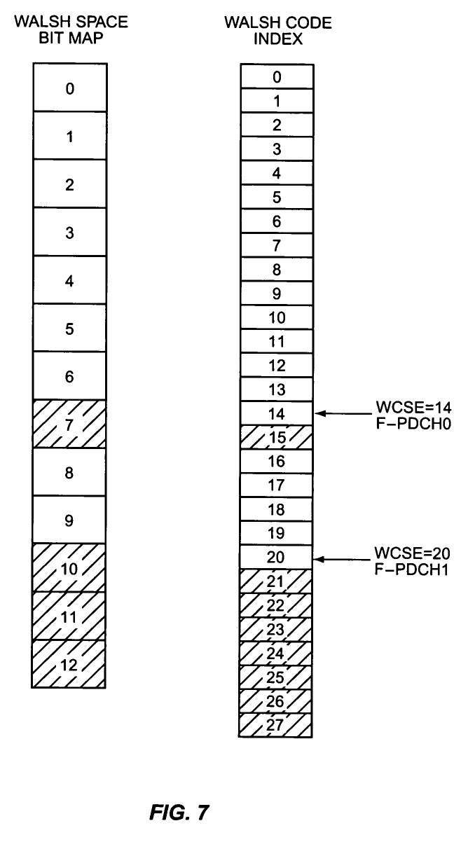

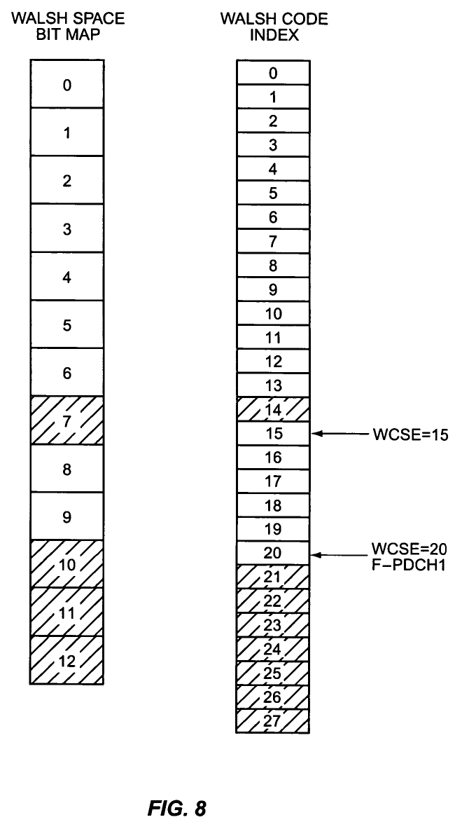

FIGS. 7 and 8 illustrate use of the WCSE where the Walsh code space is shared by two packet data channels, F-PDCH0 and F-PDCH1. Each F-PDCH is paired with a corresponding F-PDCCH. In FIG. 7, bits 7 and 10-12 in the Walsh space bitmap are set to ‘1’, the WCSE for F-PDCH0 points to Walsh code index 14, and the WCSE for F-PDCH1 points to Walsh code index 20. In this example, the mobile station designated to receive F-PDCH0 includes Walsh codes indices 0-14 in the Walsh code set for F-PDCH0, and the mobile station 100 designated to receive F-PDCH1 includes Walsh code indices 16-20 in the Walsh code set for F-PDCH1. In this example, two extra Walsh codes are gained that would not otherwise be available without the WCSE. In FIG. 8, bits 7 and 10-12 of the Walsh space bitmap are set to ‘1’, the WCSE for F-PDCH0 points to Walsh code index 15, and the WCSE for F-PDCH1 points to Walsh code index 20. In this example, the mobile station designated to receive F-PDCH0 includes Walsh code indices 0-13 and 15 in the Walsh code set for F-PDCH0, and the mobile station 100 designated to receive F-PDCH1 includes Walsh codes 16-20 in the Walsh code set for F-PDCH1. These examples show that the Walsh code set for both F-PDCH0 and F-PDCH1 can be unambiguously indicated using the signaling method of the present invention.

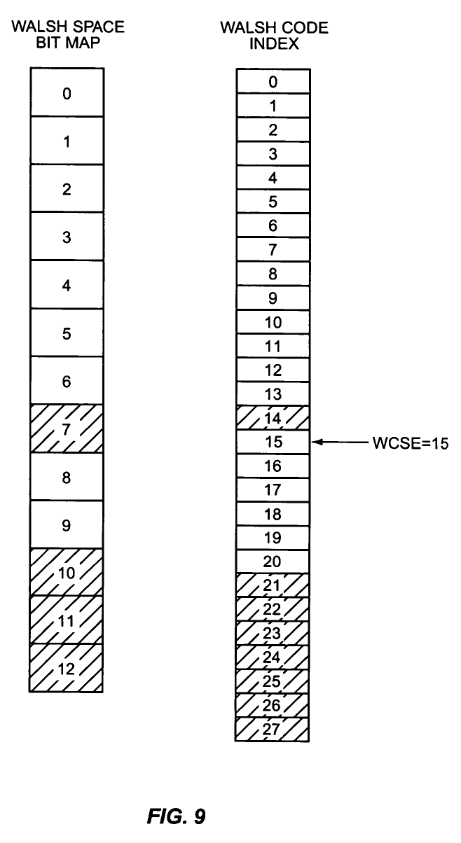

FIG. 9 illustrates an example where the Walsh code space used by a single F-PDCH is fragmented. As shown in FIG. 9, Walsh codes 14 and 21 through 27 are in use by dedicated traffic channels, while Walsh code indices 1 through 13 and 15 through 20 are unused and therefore available. This situation may arise for example when there is a momentary increase in voice calls that later drops to normal levels and one voice caller is engaged in a lengthy phone call. According to the present invention, the Walsh space bitmap can be set to ‘111001000000’ and the WCSE can be set to point to either Walsh code index 15 or Walsh code 20. The Walsh code bitmap in combination with the WCSE allows the F-PDCH to use the fragmented Walsh codes.

The Walsh space bitmap does not need to be sent with the arrival or departure of every voice call. Referring to the example in FIG. 5, when a new F-FCH is assigned for a voice call, Walsh code index 14 can be assigned without the need to send a new Walsh space bitmap. Further, any Walsh codes below Walsh code index 14 that are freed may be reassigned without the need to modify the Walsh space bitmap. Assuming there are 25 voice calls per sector on average and the call duration is about 3 min, the inter-arrival time for voice calls is about 7 sec (3×60/25). Each Walsh code can carry 2 voice calls so each bit in the Walsh space bitmap represents 4 voice calls. Therefore, assuming that a Walsh space bitmap has just been broadcast, there should be a minimum of approximately 28 seconds before the Walsh space bitmap needs to be revised in a worst case scenario. In this amount of time, up to 22,400 F-PDCH frames can be transmitted. This is a worst case scenario since Walsh codes are not always assigned from the top due to departures. In practice, the Walsh space bitmap may be sent approximately once per minute.

1. A method of indicating the Walsh code set allocated to a forward packet data channel shared by a plurality of mobile stations, said method comprising:
broadcasting a Walsh space bitmap from a radio base station to said plurality of mobile stations to indicate a set of available Walsh codes used by said forward packet data channel; and
sending a control message to a mobile station scheduled to receive the forward packet data channel to identify an unused Walsh code that is not included in the set of available Walsh codes identified by the Walsh space bitmap.

2. The method of claim 1 wherein said Walsh space bitmap comprises a plurality of bits with each bit of the Walsh space bitmap designating two or more Walsh codes, and wherein the value of bits comprising the Walsh space bitmap indicate the availability of the corresponding Walsh codes for use by the forward packet data channel.

3. The method of claim 2 wherein said control message includes a mobile station identifier indicating the scheduled mobile station and a Walsh code space expander pointing to a Walsh code marked as unavailable by the Walsh space bitmap.

4. The method of claim 1 wherein the forward packet data channel is divided into two or more subchannels.

5. A radio base station comprising:
a transmitter to transmit packet data to a plurality of mobile stations over a shared forward packet data channel;
a controller connected to said transmitter and operative to:
generate a Walsh space bitmap for transmission to said plurality of mobile stations, said Walsh space bitmap indicating a set of available Walsh codes used by said forward packet data channel;
generate a control message for transmission to a selected mobile station scheduled to receive a transmission on the forward packet data channel, wherein said control message identifies an unused Walsh code that is not included in the set of available Walsh codes identified by the Walsh space bitmap.

6. The radio base station of claim 5 wherein said Walsh space bitmap comprises a plurality of bits with each bit of the Walsh space bitmap designating two or more Walsh codes, and wherein the value of bits comprising the Walsh space bitmap indicate the availability of the corresponding Walsh codes for use by the forward packet data channel.

7. The radio base station of claim 6 wherein said control message includes a mobile station identifier indicating the scheduled mobile station and a Walsh code space expander pointing to a Walsh code marked as unavailable by the Walsh space bitmap.

8. The radio base station of claim 5 wherein the forward packet data channel is divided into two or more subchannels.

9. A method used by a mobile station to determine the Walsh code set for a forward packet data channel, the method comprising:
receiving a Walsh space bitmap from a radio base station, wherein said Walsh space bitmap comprises a plurality of bits with each bit of the Walsh space bitmap designating two or more Walsh codes, and wherein the value of bits comprising the Walsh space bitmap indicate the availability of the corresponding Walsh codes for use by the forward packet data channel; and
including the Walsh codes indicated as available by the Walsh space bitmap in the Walsh code set for the forward packet data channel;
receiving a control message from the radio base station indicating an unused Walsh code that as unavailable by said Walsh space bitmap;
adding the Walsh code indicated as being unused by the control message to the Walsh code set for the forward packet data channel.

10. The method of claim 9 wherein said Walsh space bitmap comprises a plurality of bits with each bit of the Walsh space bitmap designating two or more Walsh codes, and wherein the value of bits comprising the Walsh space bitmap indicate the availability of the corresponding Walsh codes for use by the forward packet data channel.

11. The method of claim 10 wherein said control message includes a mobile station identifier indicating the scheduled mobile station and a Walsh code space expander pointing to a Walsh code marked as unavailable by the Walsh space bitmap.

12. The method of claim 9 wherein the forward packet data channel is divided into two or more subchannels.

13. A mobile station comprising:
a receiver to receive from a radio base station packet data over a shared packet data channel, a Walsh code assignment message including a Walsh space bitmap over a forward control channel, and a packet data control message including a Walsh code space expander over a forward control channel; and
a controller connected to the receiver to determine the Walsh code set used by the packet data channel, said controller operative to:
include in the Walsh code set for the packet data channel, all channels identified as available by the Walsh space bitmap;
add to the Walsh code set for the packet data channel the Walsh code indicated by the Walsh code space expander.

14. The mobile station of claim 13 wherein said Walsh space bitmap comprises a plurality of bits with each bit of the Walsh space bitmap designating two or more Walsh codes, and wherein the value of bits comprising the Walsh space bitmap indicate the availability of the corresponding Walsh codes for use by the forward packet data channel.
